(19) United States
(12) Patent Application Publication
(10) Pub. No.: US 2026/0335978 A1
(43) Pub. Date: Oct. 29, 2026

(54) TOOL PATH GENERATION METHOD ACCORDING TO TOOL PATH PATTERN AREA, FOR MINIMIZING HEAT CONCENTRATION PHENOMENON

(71) Applicant: Korea Electronics Technology Institute, Seongnam-si (KR)

(72) Inventors: Hwa Seon SHIN, Yongin-si (KR); Sung Hwan CHUN, Seoul (KR); Jae Ho SHIN, Hanam-si (KR); Hye In LEE, Anyang-si (KR); Sung Hun PARK, Seoul (KR)

(73) Assignee: Korea Electronics Technology Institute, Seongnam-si (KR)

(21) Appl. No.: 18/867,788

(22) PCT Filed: May 9, 2023
(86) PCT No.: PCT/KR2023/006232

§ 371 Date: Jun. 15, 2026

(30) Foreign Application Priority Data
Aug. 19, 2022 (KR) 10-2022-0103711

(51) Int. Cl. B22F 10/366; B22F 10/80; B33Y 50/00; G05B 19/4103

(52) U.S. Cl. CPC B22F 10/366; B22F 10/80; B33Y 50/00; G05B 19/4103; G05B 2219/36266; G05B 2219/49023

(57) ABSTRACT

Provided is a tool path generation method according to a tool path pattern arca, for minimizing a heat concentration phenomenon. According to a tool path generation method for metal 3D printing according to an embodiment of the present invention, a 3D model is sliced into multiple single layers, the sliced single layers are divided into multiple regions, portions, on which metal is to be laminated in the divided regions, are patterned to generate pattern regions, and a tool path is generated on the basis of areas of the generated pattern regions. Therefore, on the basis of a pattern area when a laser tool path for metal laminating is generated, a heat concentration phenomenon occurring in an imperfect pattern region generated along the boundary line of laminated surfaces can be minimized.

### TECHNICAL FIELD

The disclosure relates to a metal three-dimensional (3D) printing technology, and more particularly, to a method for generating a tool path for minimizing a heat concentration phenomenon occurring in a metal 3D printing process.

### BACKGROUND ART

In a metal 3D printing process, when metal powder is melted and fixed while laser is traveling over the entire region of a laminated surface along unidirectional tool paths as shown in FIG. 1, there may be a difference in the amount of heat between lines, which reduces the degree of tissue connectivity.

Accordingly, it is generally used to construct a tool path by dividing a laminated surface into a specific shape (grid, stripe, hexagon) and then patterning the inside as shown in FIG. 2. The pattern tool path may reduce a difference in the amount of heat between lines and improve tissue connectivity.

When the laminated surface is divided by a pattern shape, imperfect pattern regions (cut pattern regions) are generated along a boundary line of the laminated surface as shown in FIG. 3. Compared to a perfect pattern region throughout which a pattern is fully formed, the imperfect pattern region includes a portion without a pattern.

The imperfect pattern region has a smaller pattern area than the perfect pattern region, and a horizontal traveling path of a laser tool in the imperfect pattern region is short, so that a cooling time is insufficient and a heat concentration phenomenon occurs. When such a heat concentration phenomenon occurs in the same portion of every layer, it may influence quality of a 3D output.

To solve the heat concentration phenomenon, skilled process operators generate a stabilized tool path through actual output while changing set values such as laser speed, etc. However, this method is impossible when there is no skilled process operator, and, even when there are skilled process operators, there may be problems that the skilled operators are not objective and undergo trial and error.

### DISCLOSURE

### Technical Problem

The disclosure has been developed in order to address the above-discussed deficiencies of the prior art, and an object of the disclosure is to provide a method for generating a tool path based on a pattern area, as a solution for minimizing a heat concentration phenomenon occurring in an imperfect pattern region generated along a boundary line of a laminated surface.

### Technical Solution

According to an embodiment of the disclosure to achieve the above-described object, a tool path generation method for metal 3D printing according to an embodiment of the disclosure may include: slicing a 3D model into a plurality of single layers; dividing the sliced single layer into a plurality of regions; generating pattern regions by patterning a portion in the divided regions where metal is to be laminated; and generating a tool path, based on areas of the generated pattern regions.

The pattern regions may be divided into perfect pattern regions throughout which patterns are fully formed, and imperfect pattern regions in which patterns are not formed in part, and generating the tool path may include generating the tool path to minimize a heat concentration phenomenon in the imperfect pattern regions.

Generating the tool path may include: generating the tool path in the perfect pattern regions; generating pattern region groups by grouping the imperfect pattern regions; and generating the tool path for the pattern region groups.

When the tool path is generated, a tool path nay not independently be generated for the imperfect pattern region.

Generating the pattern region group may include grouping the imperfect pattern regions such that the area of the pattern region group is equal to the area of the perfect pattern region.

Generating the pattern region group may include ranking the imperfect pattern regions according to pattern areas, and grouping a higher-ranked imperfect pattern region and a lower-ranked imperfect pattern region.

The number of tool path lines generated in the pattern region group may be the same as the number of tool path lines generated in the perfect pattern region.

Generating the tool path may include: generating a tool path in the perfect pattern region; and generating a tool path in a portion with a pattern in the imperfect pattern region, while adding a tool off section to a portion without a pattern.

A time of the tool off section may be inversely proportional to an area of the pattern.

According to another embodiment of the disclosure, a tool path generation system for metal 3D printing may include: a processor configured to slice a 3D model into a plurality of single layers, to divide the sliced single layer into a plurality of regions, to generate pattern regions by patterning a portion in the divided regions where metal is to be laminated; and to generate a tool path, based on areas of the generated pattern regions; and a storage unit configured to provide a storage space necessary for the process.

According to another embodiment of the disclosure, a tool path generation method for metal 3D printing may include: dividing a single layer sliced from a 3D model into a plurality of regions; and generating a tool path, based on areas of pattern regions generated by patterning a portion in the divided regions where metal is to be laminated.

According to another embodiment of the disclosure, a tool path generation system for metal 3D printing may include: a processor configured to divide a single layer sliced from a 3D model into a plurality of regions, and to generate a tool path, based on areas of pattern regions generated by patterning a portion in the divided regions where metal is to be laminated; and a storage unit configured to provide a storage space necessary for the processor.

### Advantageous Effects

As described above, according to embodiments of the disclosure, by adding a laser off section or grouping pattern regions based on pattern areas in generating a laser tool path for metal lamination, a heat concentration phenomenon occurring in an imperfect pattern region generated along a boundary line of a laminated surface may be minimized.

### DESCRIPTION OF DRAWINGS

FIG. 1 is a view illustrating unidirectional tool paths;

FIG. 2 is a view illustrating pattern tool paths;

FIG. 3 is a view illustrating examples of imperfect pattern regions occurring in boundaries of a laminated surface;

FIG. 4 is a view illustrating a laser irradiation process on a perfect pattern region;

FIG. 5 is a view illustrating a laser irradiation process on an imperfect pattern region;

FIG. 6 is a view illustrating a difference in travel time along a tool path between a perfect pattern region and an imperfect pattern region;

FIG. 7 is a view provided to explain a concept of a tool path generation method according to an embodiment of the disclosure;

FIG. 8 is a flowchart illustrating the sequence of the tool path generation method according to an embodiment of the disclosure;

FIGS. 9 to 13 are views provided to explain a concept of a tool path generation method according to another embodiment of the disclosure;

FIG. 14 is a flowchart illustrating the sequence of the tool path generation method according to another embodiment of the disclosure; and

FIG. 15 is a block diagram illustrating a tool path generation system according to still another embodiment of the disclosure.

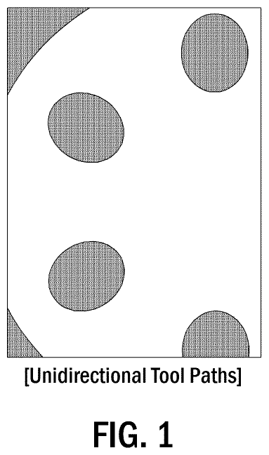

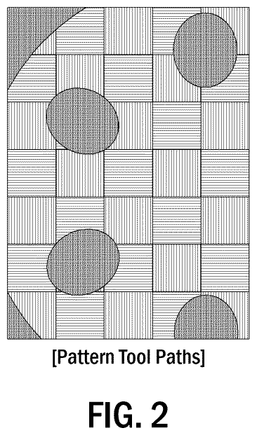

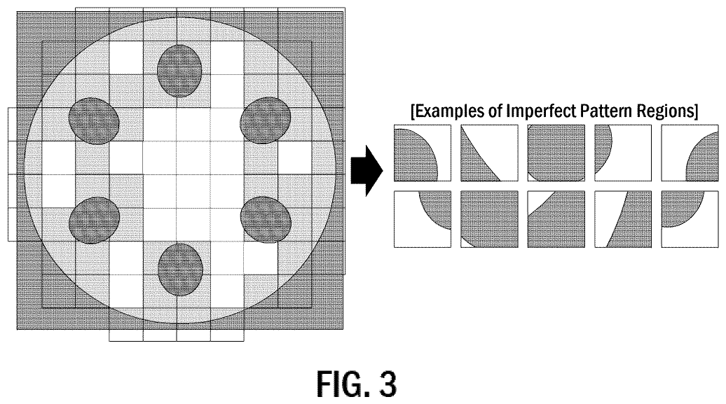

### BEST MODE

Hereinafter, the disclosure will be described in more detail with reference to the drawings.

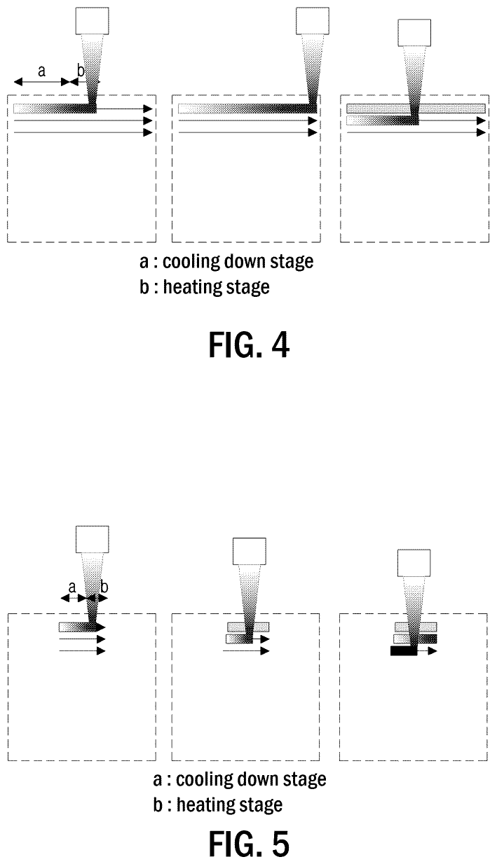

FIG. 4 illustrates a laser irradiation process on a perfect pattern region, and FIG. 5 illustrates a laser irradiation process on an imperfect pattern region. As shown in the drawings, when laser is irradiated while traveling in the horizontal direction, the point to which laser is previously irradiated is cooled immediately after the laser shifts to the side, and is expressed as a cooling down stage.

As shown in FIG. 4, the tool path line in the perfect pattern region is long enough so that when laser is irradiated to the next line, the previous line is sufficiently cooled, and thermal flattening is achieved. However, as shown in FIG. 5, the tool path line in the imperfect pattern region is short so that when laser is irradiated to the next line, residual heat remains in the previous line and heat generated by the laser irradiated to the next line is added, causing a heat concentration phenomenon.

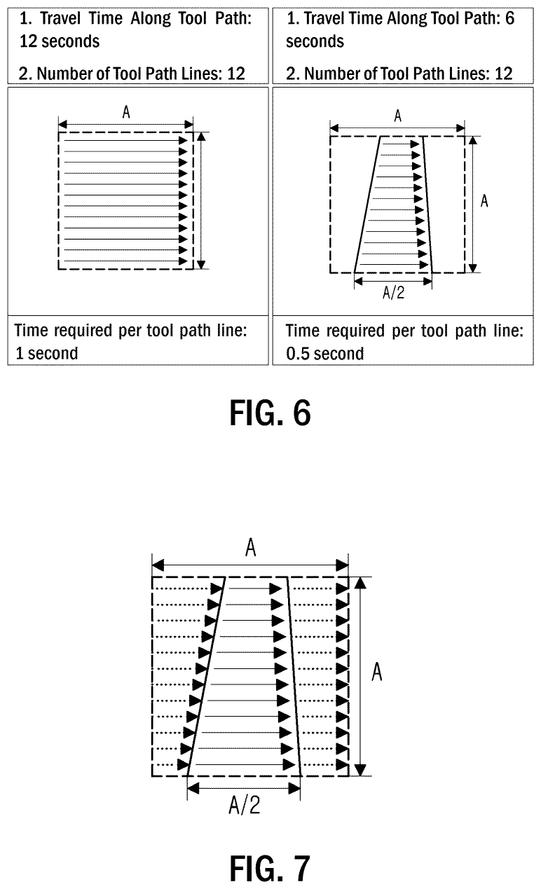

FIG. 6 is a view illustrating a difference in travel time along a tool path between the perfect pattern region and the imperfect pattern region. If the area of the imperfect pattern region (right) is about ½ of the area of the perfect pattern region (left), the tool path travel time of the imperfect pattern region is also about ½ of the perfect pattern region. That is, there is a difference in the pattern area between the perfect pattern region and the imperfect pattern region, and a heat concentration phenomenon occurs in the imperfect pattern region due to the difference in the pattern area.

Embodiments of the disclosure provide path tool generation methods for minimizing a heat concentration phenomenon based on a pattern area.

FIG. 7 is a view provided to explain a concept of a tool path generation method according to an embodiment of the disclosure.

The tool path generation method according to an embodiment is a method of adding a laser off section (dashed arrow) to turn off a laser tool for an imperfect pattern region. The laser off section is a portion where no pattern is generated, that is, a portion where a tool path (solid arrow) is not formed.

The laser tool is turned off during the laser off section. The time during which the laser tool is turned off is the same as the time required if laser is irradiated to the laser off section. To this end, the total travel time along the tool path of the imperfect pattern region becomes equal to the travel total time along the tool path of the perfect pattern region, so that the heat concentration phenomenon of the imperfect pattern region is eliminated.

The length/time of the laser off section is inversely proportional to the pattern area of the imperfect pattern region. That is, the larger the pattern area is, the shorter the length/time of the laser off section is, and the narrower the pattern area is, the longer the length/time of the laser off section is.

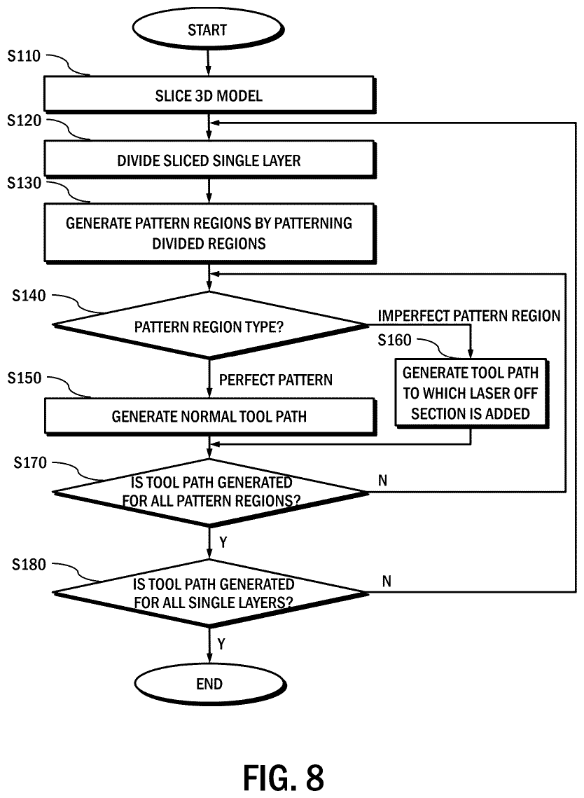

FIG. 8 is a flowchart illustrating the sequence of the tooth path generation method according to an embodiment of the disclosure.

As shown in the drawing, a 3D model for metal 3D printing is sliced at regular intervals along a Z-axis (height direction), thereby forming a plurality of single layers (S110), and tool path are generated in the unit of a single layer (S120 to S160).

Specifically, the sliced single layer is divided into a plurality of regions (S120), and pattern regions are generated by patterning a portion of the divided regions on which metal will be laminated (printed) (S130). As described above, the pattern regions generated at step S130 may include perfect pattern regions and imperfect pattern regions.

A tool path is generated in the unit of a pattern region. If the pattern region for generating the tool path is a perfect pattern region (S140—perfect pattern region), the tool path is generated in the related-art method proposed on the left of FIG. 6 (S150).

On the other hand, if the pattern region for generating the tool path is an imperfect pattern region (S140—imperfect pattern region), a tool path to which a laser off section is added is generated according to the method proposed in FIG. 7 (S160).

Steps S140 to S160 are repeated until tool paths are generated for all pattern regions of the single layer (S170). When the tools paths are generated for all pattern regions of the single layer (S170Y), steps S120 to S170 are repeated for the next single layer.

Steps S120 to S170 are repeated until tool paths are generated for all of the single layers generated at step S110 (S180).

The tool path generation method according to an embodiment adds a laser off section for cooling to a section where heat concentration is expected, thereby eliminating a heat concentration phenomenon caused by a cut pattern in the imperfect pattern region.

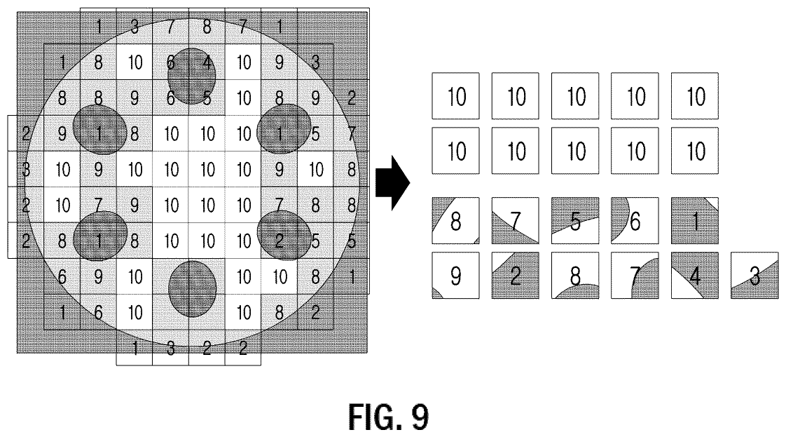

FIGS. 9 to 13 are views provided to explain a concept of a tool path generation method according to another embodiment of the disclosure.

The tool path generation method according to an embodiment of the disclosure may group imperfect pattern regions based on the pattern areas of the imperfect pattern regions, and may generate a tool path in the grouped pattern region, thereby minimizing a heat concentration phenomenon.

To achieve this, pattern regions of a single layer are divided into perfect pattern regions (upper portion of the right) and imperfect pattern regions (lower portion of the left) as shown in FIG. 9.

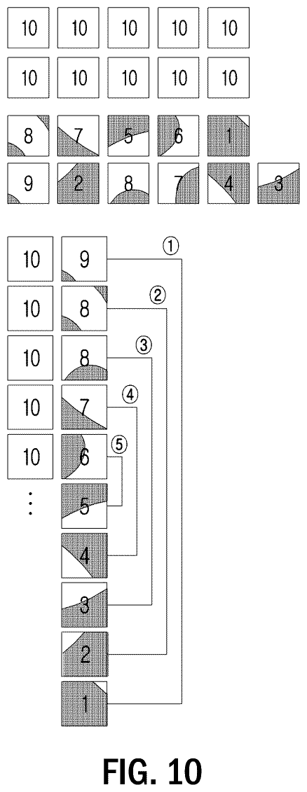

The imperfect pattern regions are ranked according to pattern areas as shown in FIG. 10, and pattern region groups are generated by grouping a high-ranked imperfect pattern region and a low-ranked imperfect pattern region.

In FIG. 10, a pattern region group \textcircled{1} is generated by grouping the imperfect pattern region having the area of “9” and the imperfect pattern region having the area of “1”, a pattern region group \textcircled{2} is generated by grouping the imperfect pattern region having the area of “8” and the imperfect pattern region having the area of “2”, . . . , a pattern region group \textcircled{5} is generated by grouping the imperfect pattern region having the area of “6” and the imperfect pattern region having the area of “5”.

While this is not always possible, it is desirable that the pattern area of the pattern region group is generated to be equal or close to the pattern area of the perfect pattern region as possible. To achieve this, it is possible to construct a pattern region group by grouping three or more imperfect pattern regions.

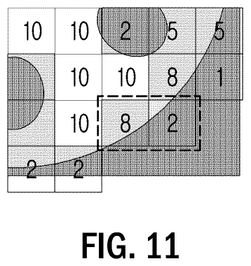

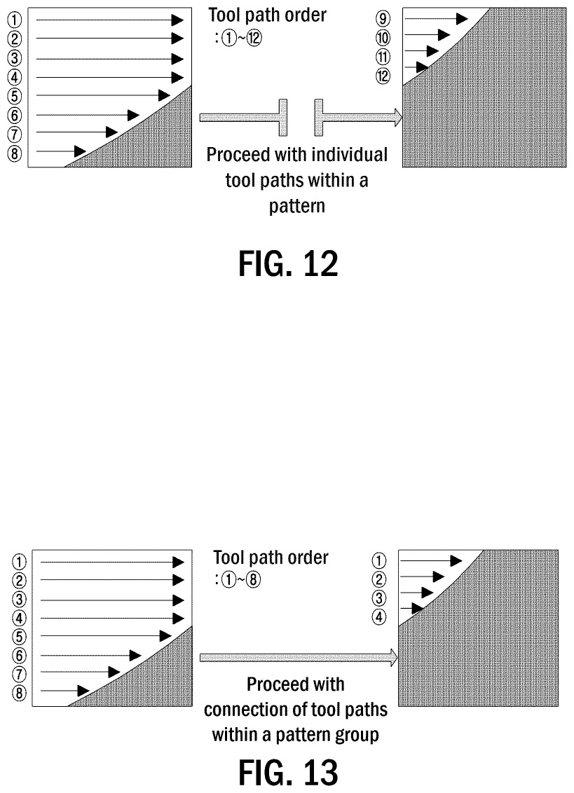

For the pattern region group generated by grouping the imperfect pattern region having the area of “8” and the imperfect pattern region having the area of “2” in FIGS. 11, 12 tool path lines may be generated in the order shown in FIG. 12 in a related-art tool path generation method. In this case, a heat concentration phenomenon may occur from the 9^{th} tool path line to the 12^{th} tool path line in the middle of advancing along the tool path.

However, according to the tool path generation method according to an embodiment of the disclosure, 8 tool path lines are generated in the order shown in FIG. 13. The 1^{st} tool path line to the 4^{th} tool path line are generated over the two imperfect pattern regions. That is, in the pattern region group generated by grouping two imperfect pattern regions, one tool path comprised of 8 lines is generated.

Meanwhile, the imperfect pattern regions forming the pattern region group in FIG. 11 are adjacent to each other. Even when a pattern region group is generated by grouping nonadjacent imperfect pattern regions, one tool path comprised of 8 lines may be generated. This is because the laser tool may discontinuously change an irradiation position. However, in this case, the tool path order may also be changed.

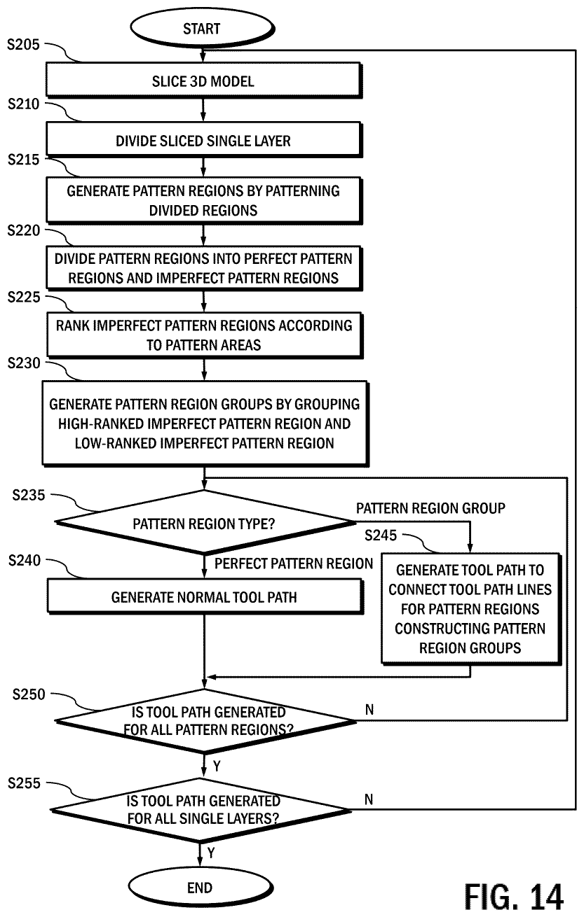

FIG. 14 is a flowchart illustrating the sequence of a tool path generation method according to another embodiment of the disclosure. Since steps S205 to S215 are the same as steps S110 to S130 shown in FIG. 8, detailed descriptions thereof are omitted.

When pattern regions are generated at step S215, the generated pattern regions are divided into perfect pattern regions and imperfect pattern regions (S220). The imperfect pattern regions are ranked according to pattern areas (S225), and pattern region groups are generated by grouping a high-ranked imperfect pattern region and a low-ranked imperfect pattern region (S230).

Preferably, at step S230, a higher-ranked imperfect patter region is grouped with a lower-ranked imperfect pattern region, such that the pattern area of the pattern region group is equal to or close to the pattern area of the perfect pattern region, and it may be possible to group three or more imperfect pattern regions.

A tool path is generated in the unit of a perfect pattern region or a pattern region group. When a tool path should be generated for a perfect pattern region (S235—perfect pattern region), the tool path is generated in the related-art method proposed on the left of FIG. 6 (S240).

On the other hand, when the tool path should be generated for the pattern region group (S235—pattern region group), the tool path is generated to connect tool path lines for the pattern regions constituting the pattern region group according to the method proposed in FIG. 13 (S245).

Steps S235 to S245 are repeated until tool paths are generated for all pattern regions of the single layer (S250). When the tool paths are generated for all of the pattern regions of the single layer (S250-Y), steps S210 to S250 are repeated for the next single layer.

Steps S210 to S250 are repeated until the tool paths are generated for all of the single layers generated at step S205 (S255).

The tool path generation method according to an embodiment of the disclosure generates the tool paths after constructing the pattern region groups by grouping the imperfect pattern regions and making the perfect pattern regions. Accordingly, a heat concentration phenomenon caused by cut patterns in the imperfect pattern regions may be eliminated.

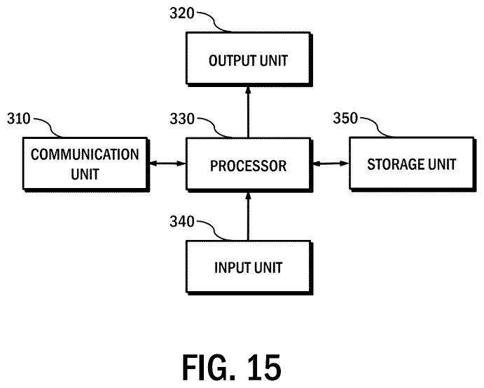

FIG. 15 is a block diagram of a tool path generation system according to still another embodiment of the disclosure. The tool path generation system according to an embodiment of the disclosure may be implemented by a computing system which includes a communication unit 310, an output unit 320, a processor 330, an input unit 340, and a storage unit 350.

The communication unit 310 is a means for communicating with external devices including a metal 3D printer and connecting to a server, a cloud, etc. through a network, and may transmit/receive/upload/download data necessary for 3D printing.

The input unit 340 is a means for receiving a user command/setting related to metal 3D printing, and the output unit 320 is a display for displaying a setting/execution screen related to metal 3D printing.

The processor 330 generates a tool path for metal 3D printing according to the procedure of FIG. 8 or 14 described above. The storage unit 350 provides a storage space necessary for functions and operations of the processor 330.

Up to now, the method for generating a tool path according to a tool path pattern area to minimize a heat concentration phenomenon has been described with reference to preferred embodiments.

In embodiments of the disclosure, by adding a laser off section or grouping pattern regions based on pattern areas in generating a laser tool path for metal lamination, a heat concentration phenomenon occurring in an imperfect pattern region generated along a boundary line of a laminated surface may be minimized.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A tool path generation method for metal 3D printing, the method comprising:
slicing a 3D model into a plurality of single layers;
dividing the sliced single layer into a plurality of regions;
generating pattern regions by patterning a portion in the divided regions where metal is to be laminated; and
generating a tool path, based on areas of the generated pattern regions.

2. The tool path generation method of claim 1, wherein the pattern regions are divided into perfect pattern regions throughout which patterns are fully formed, and imperfect pattern regions in which patterns are not formed in part, and
wherein generating the tool path comprises generating the tool path to minimize a heat concentration phenomenon in the imperfect pattern regions.

3. The tool path generation method of claim 2, wherein generating the tool path comprises:
generating the tool path in the perfect pattern regions;
generating pattern region groups by grouping the imperfect pattern regions; and
generating the tool path for the pattern region groups.

4. The tool path generation method of claim 3, wherein, when the tool path is generated, a tool path is not independently generated for the imperfect pattern region.

5. The tool path generation method of claim 3, wherein generating the pattern region group comprises grouping the imperfect pattern regions such that the area of the pattern region group is equal to the area of the perfect pattern region.

6. The tool path generation method of claim 5, wherein generating the pattern region group comprises ranking the imperfect pattern regions according to pattern areas, and grouping a higher-ranked imperfect pattern region and a lower-ranked imperfect pattern region.

7. The tool path generation method of claim 3, wherein the number of tool path lines generated in the pattern region group is the same as the number of tool path lines generated in the perfect pattern region.

8. The tool path generation method of claim 2, wherein generating the tool path comprises:
generating a tool path in the perfect pattern region; and
generating a tool path in a portion with a pattern in the imperfect pattern region, while adding a tool off section to a portion without a pattern.

9. The tool path generation method of claim 8, wherein a time of the tool off section is inversely proportional to an area of the pattern.

10. A tool path generation system for metal 3D printing, the system comprising:
a processor configured to slice a 3D model into a plurality of single layers, to divide the sliced single layer into a plurality of regions, to generate pattern regions by patterning a portion in the divided regions where metal is to be laminated; and to generate a tool path, based on areas of the generated pattern regions; and
a storage unit configured to provide a storage space necessary for the process.

11. (canceled)

12. A tool path generation system for metal 3D printing, the system comprising:
a processor configured to divide a single layer sliced from a 3D model into a plurality of regions, and to generate a tool path, based on areas of pattern regions generated by patterning a portion in the divided regions where metal is to be laminated; and
a storage unit configured to provide a storage space necessary for the processor.
